(19) United States
(12) Patent Application Publication
(10) Pub. No.: US 2011/0135801 A1
(43) Pub. Date: Jun. 9, 2011

(54) Flavor Oil Emulsions

(76) Inventors: Xiaodong Zhang, Livingston, NJ (US); Marina Kuntsevich, East Brunswick, NJ (US); John D. Keller, Freehold, NJ (US)

(21) Appl. No.: 13/057,851

(22) PCT Filed: Aug. 7, 2009
(86) PCT No.: PCT/US09/53079

§ 371 Date: Feb. 7, 2011

Related U.S. Application Data
(60) Provisional application No. 61/086,926, filed on Aug. 7, 2008.

(51) Int. Cl. A23L 2/52; A23D 9/00

(52) U.S. Cl. 426/590; 426/602

(57) ABSTRACT

Described are flavor oil emulsions, comprising at least one flavor oil and a water soluble cellulose ether present in an amount sufficient to produce a stable emulsion.

### CROSS REFERENCE TO RELATED APPLICATIONS

This application claims the benefit of U.S. Provisional Application No. 61/086,926, filed on Aug. 7, 2008.

### FIELD

The present application relates to beverage processing and formulations.

### BACKGROUND

Many beverages, including carbonated soft drinks, non-carbonated fruit drinks, sport drinks, and juices, incorporate a flavor oil to lend flavor, and in some cases, appearance properties, to the beverage. Typically, the beverage is formed by combining a larger aqueous fraction with an emulsion concentrate that contains the flavor oil. In addition to the flavor oil, the emulsion concentrate usually contains water, preservatives, acidulants, weight agents, and stabilizers (hydrocolloids) to keep the emulsion uniform over time. It is very important that the stabilizer prevents separation both of the emulsion and, after dilution, the final beverage. Not all stabilizers work equally well, however, because the stabilizer must be effective both at the low pH conditions of the emulsion and the relatively higher pH conditions of the beverage. Moreover, the stabilizer must be safe for consumption.

Over the years, gum Arabic has been a preferred stabilizer in the industry. However, gum Arabic suffers from several disadvantages, including volatile supply. Gum Arabic is derived from acacia trees in the so-called “gum belt” African countries, like Chad, Sudan, Niger, and Senegal, which have experienced drought and civil unrest. Thus, what is needed is a stabilizer for a flavor oil emulsion that has comparable performance to gum Arabic.

### SUMMARY

In one embodiment, the present invention provides flavor oil emulsions, comprising at least one flavor oil and a water soluble cellulose ether present in an amount sufficient to produce a stable emulsion.

### DESCRIPTION

In one embodiment, the present invention provides flavor oil emulsions, comprising at least one flavor oil and a water soluble cellulose ether present in an amount sufficient to produce a stable emulsion. A “stable emulsion” is one that does not separate, i.e., no water can be observed collecting below, nor oil forming on the top, of the emulsion. Not all water soluble cellulose ethers form a stable emulsion, and ones that do not are not intended to be covered by the appended claims. In one embodiment, the emulsion remains stable for at least 30 days, preferably at least 60 days, more preferably at least 90 days, most preferably at least 120 days.

Although it is not a critical feature, as there are emulsions which experience even extreme viscosity drops but remain stable, in one embodiment, the emulsion experiences a decrease in viscosity of less than 5% percent over at least 120 days, preferably less than 2%, more preferably less than 1%.

In a preferred embodiment, the water soluble cellulose ether is at least one of methyl cellulose or hydroxypropyl methyl cellulose. In one embodiment, the water soluble cellulose ether is selected from those with a Brookfield viscosity of less than about 4000 cps for a 2% solution in water at 25° C., preferably less than about 1000 cps. In a preferred embodiment, the water soluble cellulose ether is selected from those with a Brookfield viscosity of preferably less than about 150 cps, preferably less than about 100 cps, more preferably less than about 25 cps.

In one embodiment, the water soluble cellulose ether is a hydroxypropyl methyl cellulose with an MS of about 15 to about 25 and a DS of about 5 to about 15.

In one embodiment, the water soluble cellulose ether is commercially available from The Dow Chemical Company under the tradename METHOCEL K3. In one embodiment, the water soluble cellulose ether is publicly available from The Dow Chemical Company under the tradename METHOCEL A15 FG. In one embodiment, the water soluble cellulose ether is publicly available from The Dow Chemical Company under the tradename METHOCEL SGA 7C FG. In one embodiment, the water soluble cellulose ether is publicly available from The Dow Chemical Company under the tradename METHOCEL SGA 150 FG.

In one embodiment, the water soluble cellulose ether is present in an amount from about 0.1% to about 15% by weight of the emulsion forming composition, preferably in an amount from about 0.5% to about 10%, more preferably in an amount from about 1% to about 7%.

The flavor oil may be any consumable hydrophobic component that affords a taste, an odor, or both. In one embodiment, the flavor oil is selected from the group consisting of citrus oils, nut oils, coffee oils, cola oils, mint oils, including spearmint, wintergreen, and peppermint, and spice oils, including vanilla, almond, cinnamon, clove, and bay, or blends thereof. In one embodiment, the flavor oil is obtained from citrus peel. In one embodiment, the flavor oil is present in an amount from about 1% to about 30% by weight of the emulsion forming composition, preferably in an amount from about 5% to about 15%, more preferably in an amount from about 11% to about 13%.

The flavor oil emulsion may comprise additional conventional ingredients, such as water, preservatives, acidulants, or weighing agents. Examples of preservatives include sodium benzoate, sulfites, sulfur dioxide, nitrite and nitrate salts, sorbic acid, natamycin, glyceryl esters, propioic acid, and diethyl pyrocarbonate. Examples of acidulants include citric acid, lactic acid, malic acid, adipic acid, benzoic acid, fumaric acid, propionic acid, succinic acid, tartaric acid, phosphoric acid, and carbonic acid. In one embodiment, the weighing agent is at least one of a brominated vegetable oil, an ester gum, sucrose diacetate hexa-isoburtyurate, a refined gum dammar, a ganuaba wax, benzyl benzoate, a polyglyceryl ester, or a glyceryl tribenzoate. The amount of optional ingredients effective for achieving the desired property provided by such ingredients can be readily determined by one skilled in the art.

Flavor oil emulsions of the present invention can be produced by conventional emulsion-forming methods.

Gum Arabic at fairly high concentrations (20% or more) is a preferred stabilizer for conventional emulsions because of its surface active properties (from natural protein content) and good acid stability. In one embodiment, the present invention provides an at least partial replacement for gum Arabic in emulsions. Thus in one embodiment, the flavor oil emulsion contains less than about 10% gum Arabic, preferably less than about 7%, preferably less than about 5%, preferably less than about 3%, preferably less than about 1%, more preferably less than about 0.1%, most preferably less than 0.0001%.

In one embodiment, the flavor oil emulsions of the present invention can be combined with a larger aqueous fraction to form a beverage, for example, a carbonated soft drink, a non-carbonated fruit drink, a citrus flavored beverage, a sport drink, or a juice, provided that the beverage processing temperature is less than the thermogelation temperature of the water soluble cellulose ether. Thus, in one embodiment, the beverage is processed at ambient temperature.

Flavor oils help achieve turbidity in the finished beverage, giving natural fruit juice image or appearance. Cloudiness arises from the fine dispersion of essential oil droplets throughout the aqueous phase of the finished beverage. However, due to an incompatibility in specific gravity between flavoring oils (<0.9 g/ml) and finished aqueous beverage (>1.00 g/ml) stability problems can occur such as separation, evidenced by an fatty ringing effect around the neck of the container or clear liquid at the bottom of the container. It is desirable that the beverage not exhibit any separation. In one embodiment, the beverage remains stable for at least 200 days.

### EXAMPLES

The following examples are for illustrative purposes only and are not intended to limit the scope of the present invention. For reference, the water soluble cellulose ethers have approximately the Brookfield viscosities for a 2% solution in water at 25° C. described in Table 1.

TABLE 1

| | Viscosity (cps) |
|---|---|
| METHOCEL A15 FG cellulose ether | 15 |
| METHOCEL SGA150 FG cellulose ether | 150 |
| METHOCEL A4C FG cellulose ether | 400 |
| METHOCEL SGA7C FG cellulose ether | 700 |
| METHOCEL A15C FG cellulose ether | 1500 |
| METHOCEL A4M FG cellulose ether | 4000 |
| METHOCEL SGA16M FG cellulose ether | 16000 |
| METHOCEL SGA50M FG cellulose ether | 50000 |

### Example 1

Exemplary flavor oil emulsions according to the present invention contain the components recited in TABLES 1A and 1B.

TABLE 1A

| | Batch | Batch | Batch | Batch | Batch |
|---|---|---|---|---|---|
| | 1 | 2 | 3 | 4 | 5 |
| METHOCEL E5 FG | 7 | — | — | — | — |
| cellulose ether | | | | | |
| METHOCEL F50 FG | — | 2.75 | — | — | — |
| cellulose ether | | | | | |
| METHOCEL A15 FG | — | — | 4.25 | — | — |
| cellulose ether | | | | | |
| METHOCEL SG A150 FG | — | — | — | 1.8 | — |
| cellulose ether | | | | | |
| METHOCEL K3 | — | — | — | — | 7 |
| PREMIUM cellulose ether | | | | | |
| Orange Oil | 12 | 12 | 12 | 12 | 12 |
| Ester Gum | 5 | 5 | 5 | 5 | 5 |
| Citric Acid | 0.15 | 0.15 | 0.15 | 0.15 | 0.15 |
| Sodium Benzoate | 0.02 | 0.02 | 0.02 | 0.02 | 0.02 |
| Water | QC | QC | QC | QC | QC |

TABLE 1B

| | Batch | Batch | Batch | Batch | Batch |
|---|---|---|---|---|---|
| | 6 | 7 | 8 | 9 | 10 |
| METHOCEL E5 FG | 4.5 | — | — | — | — |
| cellulose ether | | | | | |
| METHOCEL F50 FG | — | 1.5 | — | — | — |
| cellulose ether | | | | | |
| METHOCEL A15 FG | — | — | 2.75 | — | — |
| cellulose ether | | | | | |
| METHOCEL SG A150 FG | — | — | — | 0.8 | — |
| cellulose ether | | | | | |
| METHOCEL K3 | — | — | — | — | 5 |
| PREMIUM cellulose ether | | | | | |
| Orange Oil | 8 | 8 | 8 | 8 | 8 |
| Ester Gum | 5 | 5 | 5 | 5 | 5 |
| Citric Acid | 0.15 | 0.15 | 0.15 | 0.15 | 0.15 |
| Sodium Benzoate | 0.02 | 0.02 | 0.02 | 0.02 | 0.02 |
| Water | QC | QC | QC | QC | QC |

Units for Tables 1A and 1B are weight percent. Amounts of cellulose ethers in Table 1A (with 12% flavor oil) are selected to have a target formulation viscosity of 250-450 cps. Amounts of cellulose ethers in Table 1B (with 8% flavor oil) are selected to have a target formulation viscosity of 25-80 cps.

To formulate, the ester gum is dissolved in the orange oil. Separately, the citric acid, sodium benzoate, and cellulose ether are dry blended. This dry blend is then added to the oil, and mixed to form a uniform slurry. Water (65° F.) is added to the slurry, mixing for about 3 min @1200 rpm with a Silverson mixer to form a pre-emulsion. The pre-emulsion is then homogenized using a MICROFLUIDICS homogenizer @3000 psi.

### Example 2

Exemplary flavor oil emulsions according to the present invention contain the components recited in TABLES 2A & 2B.

TABLE 2A

| | Batch | Batch | Batch | Batch |
|---|---|---|---|---|
| | 11 | 12 | 13 | 14 |
| METHOCEL A15 cellulose ether | 3 | — | — | — |
| METHOCEL A4C cellulose ether | — | 1 | — | — |
| METHOCEL A15C cellulose ether | — | — | 0.8 | — |
| METHOCEL A4M cellulose ether | — | — | — | 0.6 |
| Orange Oil | 12 | 12 | 12 | 12 |
| Ester Gum | 5 | 5 | 5 | 5 |
| Citric Acid | 0.15 | 0.15 | 0.15 | 0.15 |
| Sodium Benzoate | 0.02 | 0.02 | 0.02 | 0.02 |
| Water | QC | QC | QC | QC |

TABLE 2B

| | Batch | Batch | Batch | Batch | Batch |
|---|---|---|---|---|---|
| | 15 | 16 | 17 | 18 | 19 |
| METHOCEL A15 cellulose ether | — | — | — | — | 1.5 |
| METHOCEL SGA 150 cellulose | 1.05 | — | — | — | 0.5 |
| ether | | | | | |
| METHOCEL SGA 7C cellulose | — | 0.875 | — | — | — |
| ether | | | | | |
| METHOCEL SGA 16M cellulose | — | — | 0.6 | — | — |
| ether | | | | | |
| METHOCEL SGA 50M cellulose | — | — | — | 0.5 | — |
| ether | | | | | |
| Orange Oil | 12 | 12 | 12 | 12 | 12 |
| Ester Gum | 5 | 5 | 5 | 5 | 5 |
| Citric Acid | 0.15 | 0.15 | 0.15 | 0.15 | 0.15 |
| Sodium Benzoate | 0.02 | 0.02 | 0.02 | 0.02 | 0.02 |
| Water | QC | QC | QC | QC | QC |

The batches may be prepared according to the protocol described in Example 1.

### Example 3

### Comparative

Comparative compositions contain the components recited in TABLE 3.

TABLE 3

| | Comparative | Comparative |
|---|---|---|
| | Batch A | Batch B |
| Gum Arabic | 20 | 15 |
| Orange Oil | 12 | 8 |
| Ester Gum | 5 | 5 |
| Citric Acid | 0.15 | 0.15 |
| Sodium Benzoate | 0.02 | 0.02 |
| Water | QC | QC |

Amounts of gum Arabic in Batch A and B are selected to have a target formulation viscosity of 250-450 cps, and 25-80 cps, respectively. As above, to formulate, the ester gum is dissolved in the orange oil. Separately, the citric acid, sodium benzoate, and gum Arabic are dry blended. This dry blend is then added to the oil, and mixed to form a uniform slurry. Water (65° F.) is added to the slurry, mixing for about 3 min @1200 rpm with a Silverson mixer to form a pre-emulsion. The pre-emulsion is then homogenized using a MICROFLUIDICS homogenizer @3000 psi.

### Example 4

Emulsions made substantially according to the protocols described above in Examples 1 and 3 were made and are recited in TABLE 4.

TABLE 4

| | Initial | 120 day | | | |
|---|---|---|---|---|---|
| | Emulsion | Emulsion | Viscosity | 120 day | 120 day |
| | Viscosity | Viscosity | loss % | pH | Separation |
| Batch 1 | 303 | 193 | 36 | 3.2 | Significant |
| Batch 6 | 43 | 36 | 16 | 3.15 | Significant |
| Batch 2 | 324 | 96 | 70 | 3.18 | Significant |
| Batch 7 | 45 | 26 | 42 | 3.09 | Significant |
| Batch 3 | 424 | 403 | 5 | 3.27 | Slight |
| Batch 8 | 75.5 | 50 | 34 | 3.27 | Slight |
| Batch 4 | 690 | 204 | 70 | 3.16 | Slight |
| Batch 9 | 27.5 | 16 | 42 | 3.15 | Slight |
| Batch 5 | 164 | 147 | 10 | 3.43 | None |
| Batch 10 | 30 | 36 | N/A | 3.24 | None |
| Comp. | 250 | 319 | N/A | 4.19 | Slight |
| Batch A | | | | | |
| Comp. | 60 | 72 | N/A | 4.13 | None |
| Batch B | | | | | |

All emulsions were initially stable. After post-homogenization viscosity of emulsion was determined, the emulsions were transferred to glass jars, and stored on the bench top @ room temperature (˜70° F.). After 4 months, final viscosity was determined as well as visible observation of separation.

### Example 5

Emulsions made substantially according to the protocols described above in Examples 2 and 3 were made and are recited in TABLE 5.

TABLE 5

| | Initial | 30 day | | |
|---|---|---|---|---|
| | Emulsion | Emulsion | Viscosity | 30 day |
| | Viscosity | Viscosity | loss % | Separation |
| Batch 11 | 240 | 275 | N/A | None |
| Batch 12 | 198 | 120 | 39.39 | Significant |
| Batch 13 | 188 | 114 | 39.36 | Significant |
| Batch 14 | 142 | 64 | 54.93 | Significant |
| Batch 15 | 204 | 218 | N/A | None |
| Batch 16 | 185 | 103 | 44.32 | None |
| Batch 17 | 174 | 27 | 84.48 | Slight |
| Batch 18 | 185 | 24 | 87.03 | Significant |
| Batch 19 | 230 | Not | Not | None |
| | | determined | determined | |
| Comparative | 270 | 367 | N/A | None |
| Batch A | | | | |

All emulsions were initially stable. After post-homogenization viscosity of emulsion was determined, the emulsions were transferred to glass jars, and stored on the bench top @ room temperature (˜70° F.). After 1 month, 30 day viscosity was determined as well as visible observation of separation.

Batch 11 (containing low viscosity METHOCEL A15) provided excellent emulsion stability. As the viscosity of the METHOCEL cellulose used increases (Grades 4C, 15C and 4M), the corresponding emulsion batches (12, 13 and 14) are not stable after 30 days.

Batches 15 and 16 (containing METHOCEL SGA150 and SGA7C) provided good emulsion stability. As the viscosity of the METHOCEL cellulose used increases (Grades SGA16M and SGA50M), the corresponding emulsion batches (17 and 18) are not stable after 30 days.

Batch 19 contains a blend of METHOCEL A15 and METHOCEL SGA150 and shows excellent stability in 30 days.

Comparative Batch A containing Gum Arabic also shows good emulsion stability.

### Example 6

Beverages according to the present invention and a comparative example contain the components recited in TABLE 6.

TABLE 6

| | Bev. | Bev. | Bev. | Bev. | Bev. | Comparative |
|---|---|---|---|---|---|---|
| | 1 | 2 | 3 | 4 | 5 | Bev. A |
| Water | 80 | 80 | 80 | 80 | 80 | 80 |
| Sucrose | 19.65 | 19.65 | 19.65 | 19.65 | 19.65 | 19.65 |
| Citric | 0.15 | 0.15 | 0.15 | 0.15 | 0.15 | 0.15 |
| Acid | | | | | | |
| Sodium | 0.1 | 0.1 | 0.1 | 0.1 | 0.1 | 0.1 |
| Benzoate | | | | | | |
| Emulsion | 0.1 of | 0.1 of | 0.1 of | 0.1 of | 0.1 of | 0.1 of |
| | Batch 1 | Batch 2 | Batch 3 | Batch 4 | Batch 5 | Batch A |

All components except the emulsion are combined at ambient temperature. The emulsion is then added and mixed for about 1 minute with a tablespoon or the like.

### Example 7

Beverages according to the present invention and a comparative example contain the components recited in TABLE 7.

TABLE 7

| | Bev. | Bev. | Bev. | Bev. | Bev. | Bev. | Bev. | Bev. | Bev. |
|---|---|---|---|---|---|---|---|---|---|
| | 6 | 7 | 8 | 9 | 10 | 11 | 12 | 13 | 14 |
| Water | 80 | 80 | 80 | 80 | 80 | 80 | 80 | 80 | 80 |
| Sucrose | 19.65 | 19.65 | 19.65 | 19.65 | 19.65 | 19.65 | 19.65 | 19.65 | 19.65 |
| Citric | 0.15 | 0.15 | 0.15 | 0.15 | 0.15 | 0.15 | 0.15 | 0.15 | 0.15 |
| Acid | | | | | | | | | |
| Sodium | 0.1 | 0.1 | 0.1 | 0.1 | 0.1 | 0.1 | 0.1 | 0.1 | 0.1 |
| Benzoate | | | | | | | | | |
| Emulsion | 0.1 of | 0.1 of | 0.1 of | 0.1 of | 0.1 of | 0.1 of | 0.1 of | 0.1 of | 0.1 of |
| | Batch 11 | Batch 12 | Batch 13 | Batch 14 | Batch 15 | Batch 16 | Batch 17 | Batch 18 | Batch 19 |

The beverages may be prepared according to the protocol described in Example 6.

### Example 8

Beverages made substantially according to the protocols described above in Example 6 were made and are recited in TABLE 8.

TABLE 8

| | | | | Visually |
|---|---|---|---|---|
| | | | | Acceptable |
| | Initial | 7 Month | 7 Month | Clouding |
| | Haze | Haze | Turbidity | Effect |
| Bev. 1 | 90.33 | 21.46 | 41.25 | No |
| Bev. 2 | 91.17 | 73.31 | 267.22 | Yes |
| Bev. 3 | 91.09 | 71.55 | 251.37 | Yes |
| Bev. 4 | 90.87 | 54.39 | 147.59 | Yes |
| Bev. 5 | 87.20 | 40.04 | 89.69 | No |
| Comparative | 91.35 | 64.37 | 196.44 | Yes |
| Bev. A | | | | |

Beverages were prepared using flavor emulsions within a week of making. The ability of beverages to retain proper clouding effect over time was assessed by measuring turbidity (% Haze and/or mg/L solids) using a Nippon Senshoku COH-300A Color-Oil-Haze measuring device. Samples were loaded into an 80 ml sample cell and light transmittance/scattering was determined against a blank cell measurement. Although the Methocel K3 containing flavor emulsions showed good stability after 7 months, the corresponding beverage (Beverage 5) had significant reduction in opacity of the formulations and is not acceptable. On the other hand, Methocel A15, Methocel SGA 150 and Gum Arabic provide acceptable stability for the flavor emulsions (batch 3, 4 and comparative batch A) and acceptable clouding effect (beverage 3, 4 and comparative beverage A).

### Example 9

Beverages made substantially according to the protocols described above in Example 7 were made and are recited in TABLE 9.

TABLE 9

| | Initial | Haze after 30 | Stability after 30 |
|---|---|---|---|
| | Haze | days storage | days storage |
| Bev. 6 | 87.76 | 70.46 | Yes |
| Bev. 7 | 91.04 | 87.18 | No |
| Bev. 8 | 91.26 | 87.65 | No |
| Bev. 9 | 90.69 | 84.42 | No |
| Bev. 10 | 91.11 | 87.21 | Yes |
| Bev. 11 | 91.27 | 87.36 | Yes |
| Bev. 12 | 91.29 | 87.79 | No |
| Bev. 13 | 91.25 | 88.61 | No |
| Bev. 14 | 91.38 | — | Yes |
| Comparative Bev. A | 91.2 | 88.21 | Yes |

Beverages were prepared using flavor emulsions within a week of making. The initial haze, haze after 30 days, beverage stability, and visually acceptable opacity were determined for these batches. All beverage samples have acceptable visual clouding effect after one month of storage. Cloudiness is likely to be related to droplet coalescence, but not fully correlated with beverage stability. Beverage stability appeared to follow emulsion stability.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and subcombinations of ranges, as well as specific numerals contained therein. Additionally, the disclosures of each document cited or described in this specification are hereby incorporated herein by reference, in their entireties.

1. A flavor oil emulsion, comprising:
at least one flavor oil; and
a water soluble cellulose ether present in an amount sufficient to produce a stable emulsion; and
wherein the emulsion experiences a decrease in viscosity of less than 5% percent over at least 120 days, preferably less than 2%, more preferably less than 1%.

2. The flavor oil emulsion of claim 1, wherein the flavor oil is selected from the group consisting of citrus oils, coffee oils, cola oils, mint oils, including spearmint, wintergreen, and peppermint, and spice oils, including vanilla, almond, cinnamon, clove, and bay, or blends thereof.

3. The flavor oil emulsion of claim 1, wherein the flavor oil is present in an amount from about 1% to about 30% by weight of the emulsion forming composition, preferably in an amount from about 5% to about 15%, more preferably in an amount from about 11% to about 13%.

4. The flavor oil emulsion of claim 1, wherein the emulsion remains stable for at least 30 days, preferably at least 60 days, more preferably at least 90 days, most preferably at least 120 days.

5. (canceled)

6. The flavor oil emulsion of claim 1, wherein the water soluble cellulose ether is at least one of methyl cellulose or hydroxypropyl methyl cellulose.

7. The flavor oil emulsion of claim 6, wherein the water soluble cellulose ether is selected from those with a Brookfield viscosity of less than about 4000 cps for a 2% solution in water at 25° C., preferably less than about 1000 cps, preferably less than about 150 cps, preferably less than about 100 cps, more preferably less than about 25 cps.

8. The flavor oil emulsion of claim 6, wherein the water soluble cellulose ether is a hydroxypropyl methyl cellulose with an MS of about 15 to about 25 and a DS of about 5 to about 15.

9. The flavor oil emulsion of claim 1, wherein the water soluble cellulose ether is present in an amount from about 0.1% to about 15% by weight of the emulsion forming composition, preferably in an amount from about 0.5% to about 10%, more preferably in an amount from about 1% to about 7%.

10. The flavor oil emulsion of claim 1, further comprising at least one of water, preservatives, acidulants, or weighing agents.

11. The flavor oil emulsion of claim 10, wherein the weighing agent is at least one of a brominated vegetable oil, an ester gum, sucrose diacetate hexa-isoburtyurate, a refined gum dammar, a ganuaba wax, benzyl benzoate, a polyglyceryl ester, or a glyceryl tribenzoate.

12. The flavor oil emulsion of claim 1, provided that the flavor oil emulsion contains less than about 10% gum Arabic, preferably less than about 7%, preferably less than about 5%, preferably less than about 3%, preferably less than about 1%, more preferably less than about 0.1%, most preferably less than 0.0001%.

13. A beverage processed from the flavor oil emulsion of claim 1, provided that the beverage processing temperature is less than the thermogelation temperature of the water soluble cellulose ether.

14. The beverage of claim 13, wherein the beverage is processed at ambient temperature.

15. The beverage of claim 13, wherein the beverage is a carbonated beverage.

16. The beverage of claim 13, wherein the beverage is not a carbonated beverage.

17. The beverage of claim 13, wherein the beverage is a citrus flavored beverage.

18. The beverage of claim 13, wherein the beverage remains stable for at least 200 days.
